(19) United States
(12) Patent Application Publication
(10) Pub. No.: US 2010/0320709 A1
(43) Pub. Date: Dec. 23, 2010

(54) Hand truck

(76) Inventor: Charles R. Williamson, Franklin, NC (US)

Correspondence Address: LITMAN LAW OFFICES, LTD., PATENT LAW BUILDING, 8955 CENTER STREET, MANASSAS, VA, 20110, US

(21) Appl. No.: 12/457,695

(22) Filed: Jun. 18, 2009

(51) Int. Cl. B62B 1/00

(52) U.S. Cl. 280/47.3

(57) ABSTRACT

The hand truck is configured for the carriage of large, heavy, generally cylindrical buckets of wallboard compound, paint, etc. The handlebars include one or more latch bars extending therebetween, with each latch bar having a fixed bale latch. The latch bars and bale latches are configured so that when a standard material bucket is placed on the platform when the platform is resting on the surface, the bale of the bucket will clear the bale latch when the bale is swung rearwardly toward the handlebars. However, when the truck is tilted rearwardly for transport, the bucket tilts forwardly and the bale catches on the bale latch, thereby securing the bucket on the truck. When the truck is repositioned with the platform resting on the surface, the handlebars swing toward the upper edge of the bucket to provide sufficient slack to allow the bale to be removed from the bale latch.

### BACKGROUND OF THE INVENTION

1. Field of the Invention

The present invention relates generally to manually powered wheeled conveyances, and particularly to a hand truck that is particularly adapted for the carriage of large, heavy buckets of material.

2. Description of the Related Art

Innumerable manually powered, wheeled contrivances have been developed in the past to facilitate the carriage of various large and/or heavy articles. Conventional wheelbarrows and hand trucks are both well-known examples of such devices.

While the above conveyances are reasonably adaptable, they have their limitations when it comes to carrying certain materials or articles that may have less than optimum stability. An example of such is the carriage of a conventional multi-gallon container of liquid or fluid material, e.g., wallboard “mud” or compound, paint, mortar or grout, etc. These containers are nearly universally in a generally cylindrical form, albeit generally slightly tapered. Such containers may have a volume of five gallons or more, with the material carried therein having a density greater than water. The typical weight of such a loaded five-gallon bucket is on the order of fifty pounds, or perhaps considerably more.

Accordingly, such buckets are provided with handles or bales to allow a person to carry them more readily by hand. Nonetheless, the lifting and carriage of even one such container is extremely wearing for even a very fit person, particularly when it must be carried over some distance. Yet, the conventional hand truck is ill suited for the carriage of such buckets of material, as they are not equipped to secure such cylindrically shaped articles in place. Additional components, such as bungee cords, ropes, etc., must be gathered and used to secure the bucket(s) to the hand truck. Even so, the bucket(s) may tend to roll laterally due to their cylindrical shape and the lack of positive engagement provided by a cord or the like wrapped around the bucket(s) and the generally wider span of the handles of the truck, thereby seriously reducing the lateral stability of the loaded hand truck.

Thus, a hand truck solving the aforementioned problems is desired.

### SUMMARY OF THE INVENTION

The hand truck is configured for carrying one or more large, generally cylindrical buckets of material, such as five-gallon buckets of wallboard compound, paint, mortar or grout, etc. The hand truck includes a lower platform having a pair of laterally spaced handlebars extending upwardly therefrom, normal to the plane of the platform. A single wheel extends rearwardly from the rear of the platform and is captured between a pair of cantilever arms. The bottom of the wheel is coplanar with the bottom of the platform. One or more latch bars extend across the handlebars. A bale latch extends upwardly and rearwardly from each latch bar.

A bucket is placed upon the platform when the truck is in the upright position, and the handle or bale of the bucket is swung upwardly and rearwardly to pass over the corresponding bale latch. The latch bar and bale latch are positioned to allow the bale of the bucket to clear the bale latch when the bottom of the bucket is coplanar with the upper surface of the platform. However, when the handlebars of the truck are tilted rearwardly to transport the load, the bucket tends to tilt forwardly from the relatively narrow platform. As the top of the bucket tilts forwardly and away from the handlebars, the bale also pulls forward, catching on the bale latch to secure the bucket in place and prevent it from falling from the truck. When the load has been delivered to the desired location, the truck is once again tilted upright, with the handlebars again approaching the top of the bucket. This results in some slack between the bale latch of the hand truck and the bale of the bucket, allowing the bale to clear the bale latch as it is swung forwardly for removal of the bucket from the hand truck.

These and other features of the present invention will become readily apparent upon further review of the following specification and drawings.

### BRIEF DESCRIPTION OF THE DRAWINGS

FIG. 1 is a perspective view of a hand truck according to the present invention, illustrating its general features.

FIG. 2 is an environmental side elevation view of the hand truck of FIG. 1, shown with a load resting upon the platform surface and showing the relative positions of the bucket handles and handle latches of the hand truck in a rest position.

FIG. 3 is an environmental side elevation of the hand truck of FIG. 1, shown in a cargo carrying position, showing the retention of the bucket handles by the handle latches.

Similar reference characters denote corresponding features consistently throughout the attached drawings.

### DETAILED DESCRIPTION OF THE PREFERRED EMBODIMENTS

The present invention relates to a hand truck particularly configured or adapted for the carriage of relatively large and heavy multi-gallon containers of fluids, such as wallboard compound, paint, and the like. The hand truck includes means for automatically securing the handle or bail of the bucket(s) to the truck when the truck is tilted back for transport of such a bucket(s), and automatically releasing the bale when the truck is returned to an upright position with its platform resting upon the underlying surface.

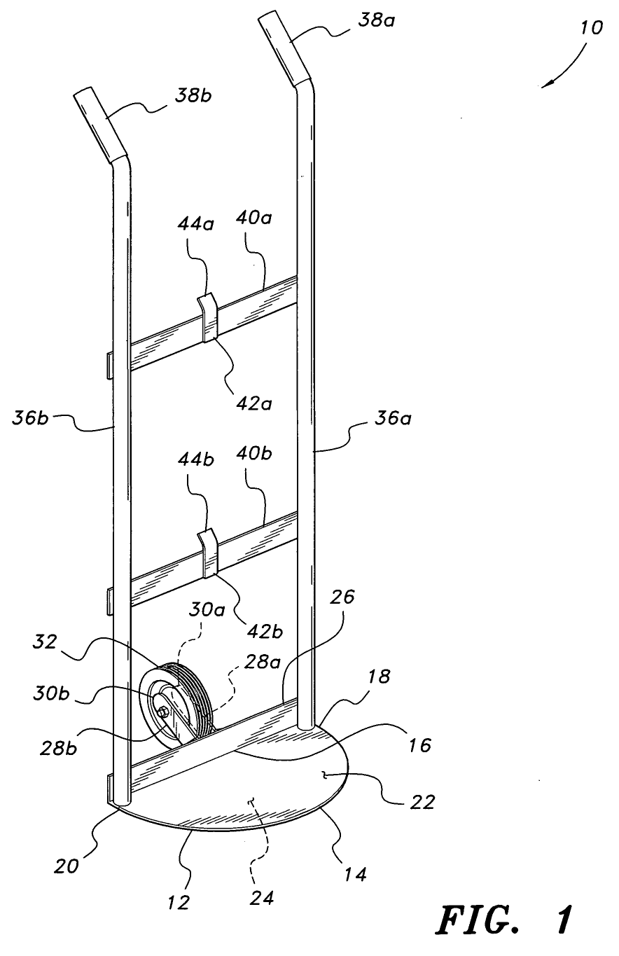

FIG. 1 of the drawings provides a front perspective view of the hand truck 10, illustrating its general features. The hand truck 10 includes a forwardly disposed platform 12 having a generally semicircular planform and comprises a rigid metal plate having a curved forward edge 14, an opposite rearward edge 16, a left side 18, an opposite right side 20, an upper surface 22, and an opposite lower surface 24. The platform 12 serves to support a load thereon and is preferably formed of a reasonably thick sheet or plate of metal, such as sixteen-gauge or thicker steel, etc. Thicker sheets of softer metal, e.g., aluminum, etc., may be used if so desired. A length of angle iron 26 may be welded or otherwise permanently affixed to the rear edge 16 of the platform 12 if so desired, for additional strength.

A first and a second wheel strut, respectively 28a and 28b, are cantilevered rearwardly from the rear edge 16 of the platform 12, or more specifically from the upwardly oriented flange of the angle iron 26. The two wheel struts 28a, 28b may be formed of reasonably rigid sheet stock or other suitable material, and are parallel to one another and define a wheel capture span therebetween. The spaced apart distal ends 30a, 30b of the two struts 28a, 28b capture a single wheel 32 therebetween. It will be seen that the wheel 32 may be supported by a single strut or by other means if so desired, and/or additional wheels may be added for additional stability if so desired. However, the use of a single wheel serves adequately and reduces the weight of the hand truck 10 to facilitate transport.

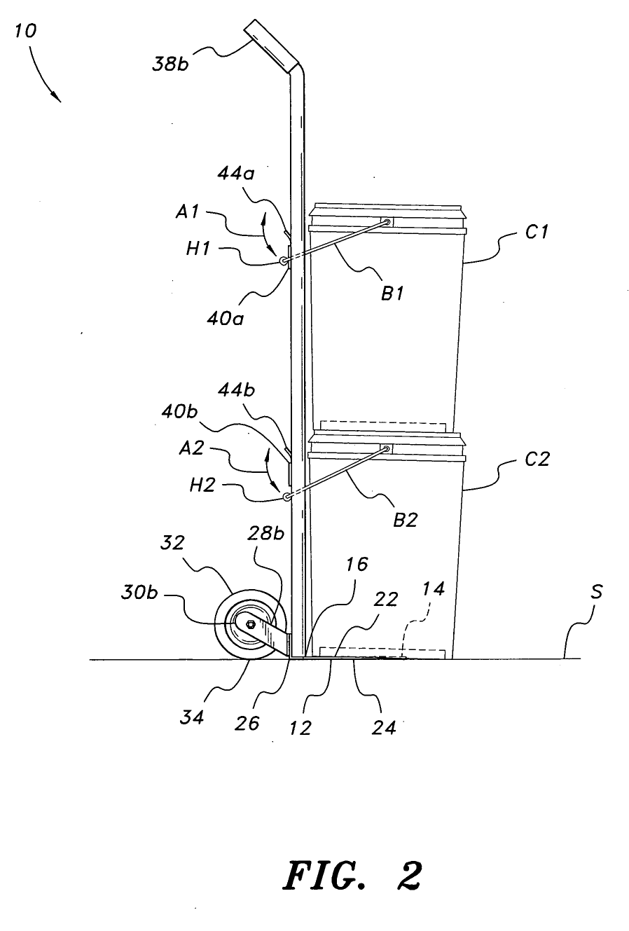

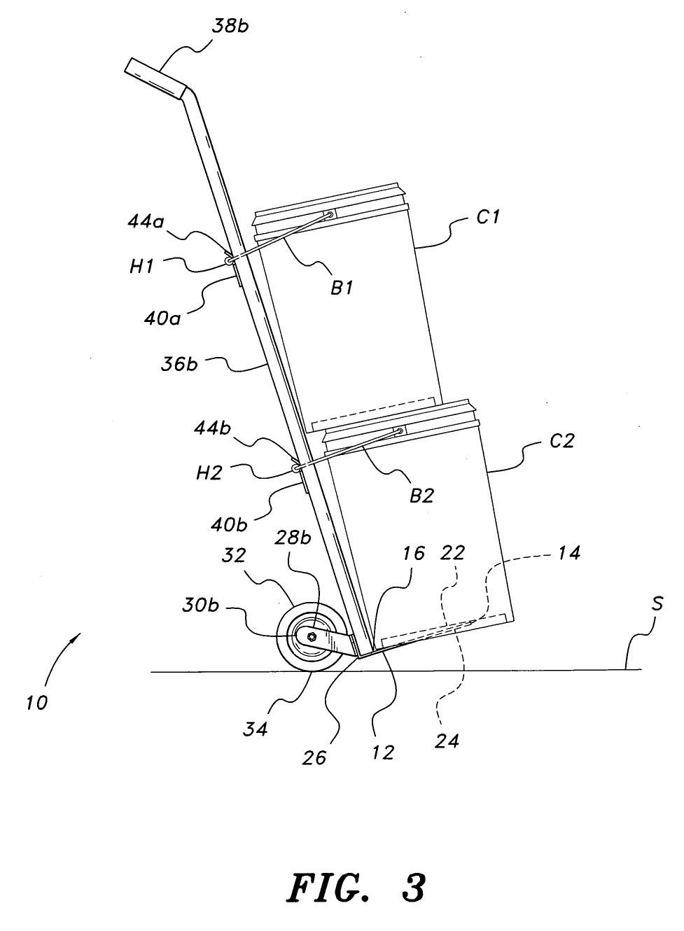

The two wheel struts 28a, 28b will be seen in FIGS. 2 and 3 to angle upwardly and rearwardly relative to the plane of the platform 12, with their lengths and the wheel diameter selected to place the lowermost point 34 of the wheel 32 coplanar with the bottom surface 24 of the platform 12. The wheel 32 is positioned to serve as an intermediate fulcrum between the forwardly extending platform 12 and the handlebars, when the hand truck 10 is tilted rearwardly for the transport of some article(s) thereon.

Left and right handlebars, respectively 36a and 36b, extend upwardly from the left and right sides of the platform 12, adjacent the rear edge 16 thereof. The handlebars 36a, 36b are preferably substantially normal to the plane of the platform 12 and terminate in distal handle ends, respectively 38a and 38b. At least one, and preferably two, latch bars, respectively 40a and 40b, extend laterally across or between the two handlebars 36a, 36b and are permanently affixed (e.g., welded, etc.) thereto. Each of the latch bars 40a, 40b serves to support a bale latch, respectively 42a and 42b, extending upwardly and rearwardly therefrom. Each of the bale latches 42a, 42b comprises a rigid metal tab welded or otherwise permanently affixed to its respective latch bar 40a, 40b, with a distal extremity, respectively 44a, 44b, bent upwardly and rearwardly from the respective latch bar 40a, 40b.

FIGS. 2 and 3 illustrate the operation of the hand truck 10 in securing two buckets or containers C1 and C2 of material thereon for transport. In FIG. 2, the hand truck 10 is in its rest position with the lower surface 24 of the platform 12 resting upon the underlying surface S. The rearward portion of the lowermost container C2 is resting upon the upper surface 22 of the platform 12, with the forward portion of the container resting upon the underlying surface S. The upper container C1 is seated upon the lid of the lower container C2. As the bottom of the lower container C2 is essentially coplanar with the upper surface 22 of the platform 12, it will be seen that positioning the containers C1 and C2 close to the handlebars 36a, 36b positions the bales B1 and B2 of the containers C1 and C2 sufficiently close to the bale latches, or more specifically to their distal extremities 44a and 44b, that the handles H1, H2 of the two bales B1, B2 will swing over and clear the extremities 44a, 44b of the two bale latches 42a, 42b, as indicated by the bale movement arrows A1, A2 in FIG. 2. Thus, the user need only place the two containers C1, C2 on the platform 12 of the hand truck 10 and position them immediately adjacent to the handlebars 36a, 36b, to be assured that the bale handles H1, H2 will clear the bale latch extremities 44a, 44b.

In FIG. 3, the hand truck 10 has been tilted rearwardly about the wheel 32, lifting the platform 12. The platform 12 is relatively narrow in its forward—rearward span, and does not provide complete support for the full diameter of the bottom of the lower container C2. This is particularly true due to the conventionally recessed bottom of such containers, as shown in broken lines in FIGS. 2 and 3. The platform will tend to rise into the recessed bottom, or more correctly, the container C2 will tend to tip forwardly on the platform 12. This results in the bale B2 and its handle H2 pulling forwardly, as well, as the top of the container C2 moves forwardly away from the handlebars 36a, 36b. However, as the handle H2 is located behind the upwardly and rearwardly angled distal extremity 44b of the bale latch, the handle H2 catches on the latch extremity and is prevented from further forward movement relative to the truck 10, thus preventing the bucket or container C2 from tipping forwardly from the platform 12 and securing the container to the truck. The upper container C1 is retained in a similar manner, as it also will tend to tip forwardly as it rests atop the lower container C2.

When the hand truck 10 is once again tilted forwardly to allow the platform 12 to rest upon the underlying surface S, the forward portion of the lower container C2 also contacts the surface, which results in the container C2 (and an upper container C1, if placed atop the lower container C2) moving back toward the handlebars 36a, 36b. This results in some slack or space between the container handles H1 and H2 relative to their bale latch extremities 44a and 44b, generally as shown in FIG. 2, and allows the handles Hi and H2 to be raised and pivoted forwardly for removal of the containers C1 and C2 from the hand truck 10.

It will be seen that the hand truck 10 is particularly configured to facilitate the carriage of large buckets of material without need for additional bungees, ropes, cords, etc. to secure the buckets to the truck. However, it will be noted that the hand truck 10 may be used to carry and transport other articles as well, by means of appropriate tiedowns or other attachments. Accordingly, the versatility of the hand truck will prove to be of great value in many areas, particularly in the warehousing and construction industries where the carriage of such large buckets of material is routinely required.

It is to be understood that the present invention is not limited to the embodiment described above, but encompasses any and all embodiments within the scope of the following claims.

I claim:

1. A hand truck, comprising:
a thin, rigid platform having a forward edge, a rearward edge opposite the forward edge, a left side, a right side, an upper surface, and a lower surface opposite the upper surface;
at least one wheel extending rearwardly from the platform;
a left handlebar and a right handlebar extending respectively from the left side and the right side of the platform adjacent the rearward edge thereof normal thereto;
at least one latch bar immovably affixed between the handlebars; and
a bale latch immovably affixed to the latch bar and extending upwardly and rearwardly therefrom.

2. The hand truck according to claim 1 wherein the at least one wheel consists of a single wheel extending rearwardly from the platform, the wheel having a lowermost point coplanar with the lower surface of the platform, the wheel defining a fulcrum disposed generally between the platform and the handlebars.

3. The hand truck according to claim 1, further comprising at least one wheel strut cantilevered from the rear of the platform, the wheel strut having a distal end, the at least one wheel being disposed upon the distal end of the wheel strut.

4. The hand truck according to claim 1, wherein the platform is substantially semicircular, the forward edge being arcuate.

5. The hand truck according to claim 1, wherein the bale latch comprises a rigid tab extending upwardly from the latch bar, the tab having a rearwardly bent upper extremity.

6. The hand truck according to claim 1, further comprising spaced apart, mutually parallel first and second wheel struts rigidly affixed to and cantilevered from the rear of the platform, the wheel struts each having a distal end, the at least one wheel being captured between the distal ends of the wheel struts.

7. A hand truck, comprising:
a thin, rigid platform having a forward edge, a rearward edge opposite the forward edge, a left side, a right side, an upper surface, and a lower surface opposite the upper surface;
a left handlebar and a right handlebar extending respectively from the left side and the right side of the platform adjacent the rearward edge thereof normal thereto; and
a single wheel extending rearwardly from the platform, the wheel having a lowermost point coplanar with the lower surface of the platform, the wheel defining a fulcrum disposed generally between the platform and the handlebars.

8. The hand truck according to claim 7, further comprising:
at least one latch bar immovably affixed between the handlebars; and
a bale latch immovably affixed to the latch bar and extending upwardly and rearwardly therefrom.

9. The hand truck according to claim 8, wherein the bale latch comprises a rigid tab extending upwardly from the latch bar, the tab having a rearwardly bent upper extremity.

10. The hand truck according to claim 7, further comprising at least one wheel strut rigidly affixed to and cantilevered from the rear of the platform, the wheel strut having a distal end, the wheel being disposed upon the distal end of the wheel strut.

11. The hand truck according to claim 7, wherein the platform is semicircular, the forward edge being arcuate.

12. The hand truck according to claim 7, further comprising spaced apart, mutually parallel first and second wheel struts rigidly affixed to and cantilevered from the rear of the platform, the wheel struts each having a distal end, the wheel being captured between the distal ends of the wheel struts.

13. A hand truck, comprising:
a thin, rigid platform having a forward edge, a rearward edge opposite the forward edge, a left side, a right side, an upper surface, and a lower surface opposite the upper surface;
a left handlebar and a right handlebar extending respectively from the left side and the right side of the platform adjacent the rearward edge thereof normal thereto;
at least one wheel strut rigidly affixed to and cantilevered from the rear of the platform, the wheel strut having a distal end; and
at least one wheel disposed upon the distal end of the wheel strut, the wheel defining a fulcrum disposed generally between the platform and the handlebars.

14. The hand truck according to claim 13, further comprising:
at least one latch bar immovably affixed between the handlebars; and
a bale latch immovably affixed to the latch bar and extending upwardly and rearwardly therefrom.

15. The hand truck according to claim 14, wherein the bale latch comprises a rigid tab extending upwardly from the latch bar, the tab having a rearwardly bent upper extremity.

16. The hand truck according to claim 13, wherein the at least one wheel comprises a single wheel, the wheel having a lowermost point coplanar with the lower surface of the platform, the wheel defining a fulcrum disposed generally between the platform and the handlebars.

17. The hand truck according to claim 13, wherein the platform is semicircular, the forward edge being arcuate.

18. The hand truck according to claim 13, further comprising spaced apart, mutually parallel first and second wheel struts rigidly affixed to and cantilevered from the rear of the platform, the wheel struts each having a distal end, the at least one wheel being captured between the distal ends of the wheel struts.
